(19) United States
(12) Patent Application Publication
(10) Pub. No.: US 2026/0278469 A1
(43) Pub. Date: Sep. 17, 2026

(54) Systems and Methods for Dynamic Control of Machine Learning Parameters

(71) Applicant: Mentavi Health, Grand Rapids, MI (US)

(72) Inventors: Keith Douglas Brophy, Byron Center, MI (US); Barry Keith Herman, Henderson, NV (US); Michelle Renee Ripper Lewis, Caledonia, MI (US); Steven Richard Goulet, East Grand Rapids, MI (US)

(73) Assignee: Mentavi Health, Grand Rapids, MI (US)

(21) Appl. No.: 19/565,363

(22) Filed: Mar. 12, 2026

Related U.S. Application Data
(60) Provisional application No. 63/770,681, filed on Mar. 12, 2025.

(51) Int. Cl. G06N 20/00

(52) U.S. Cl. CPC G06N 20/00

(57) ABSTRACT

Systems and methods for dynamic control of machine learning parameters, allowing for modification of weights for input values and vectors during processing. Implementations of these systems provide greater flexibility without requiring extensive retraining of a model, and may improve accuracy of classifications for diagnostic systems or other analyzers.

### RELATED APPLICATIONS

The present application claims the benefit of and priority to U.S. Provisional Patent Application No. 63/770,681, entitled “Dynamic Control of Machine Learning Parameters,” filed Mar. 12, 2025, the entirety of which is incorporated by reference herein.

### TECHNICAL FIELD

The present embodiments generally relate to systems and methods for machine learning algorithms. In particular, the present embodiments are directed to implementations of dynamic control of machine learning parameters during runtime.

### BACKGROUND

Machine learning models are typically trained through an extensive time- and resource-consuming process, frequently requiring days or months of intense processing of large (frequently dozens or even hundreds of terabytes) datasets by large numbers of processing devices with recursive adjustment and retraining of model weights and biases or other internal parameters. Once trained, these models are essentially fixed, without further adjustment of the parameters until retraining is performed.

### SUMMARY

In some aspects, the present disclosure is directed to implementations of systems and methods for dynamic control of machine learning parameters, allowing for modification of weights for input values and vectors during processing. Implementations of these systems provide greater flexibility without requiring extensive retraining of a model, and may improve accuracy of classifications for diagnostic systems or other analyzers.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout.

FIG. 1 is a block diagram of an implementation of a system for dynamic control of machine learning parameters;

FIG. 2 is a block diagram of an implementation of dynamic control of machine learning parameters during processing;

FIG. 3 is a flow chart of an implementation of a method for dynamic control of machine learning parameters during processing; and

FIG. 4 illustrates a block diagram of a system within which aspects of the present embodiments may be implemented.

### DETAILED DESCRIPTION

For purposes of reading the description of the various embodiments below, the following descriptions of the sections of the specification and their respective contents may be helpful:
Section A describes embodiments of systems and methods for dynamic control of machine learning parameters; and
Section B describes a computing environment which may be useful for practicing embodiments described herein.

### A. Systems and Methods for Dynamic Control of Machine Learning Parameters

Implementations of machine learning-based systems, such as neural networks, are typically trained on very large datasets through a supervised learning process in order to optimize internal parameters, such as weights of connections between neurons and biases or offsets of activation functions. This may require many iterations of setting and adjusting parameters, and can require days or months of computation by many processing devices in parallel. Because once trained, the parameters are fixed until future retraining is performed, and because retraining is time and resource expensive, a machine learning system may become stagnant and unable to adjust to new data or perform complex internal adjustments that change classifications or predictions for given input data. While models may be expanded to provide greater flexibility (e.g. adding additional hidden layers to a neural network or expanding the number of input neurons), this frequently comes at a cost of both more expensive training as well as reduced accuracy or sensitivity.

Instead, using implementations of the systems and methods discussed herein, input data provided to a trained model may be pre-processed and dynamically scaled with weights based on the input data values and/or other data, providing greater flexibility. For example, rather than using a larger neural network with additional hidden layers and interconnections and thus requiring more resources for training and processing, input data may be dynamically adjusted or modified before being provided to a smaller trained network with greater control and modifications specific to the dataset or context. Accordingly, a trained neural network may be applied to different sets of pre-processed input data and achieve higher accuracy without retraining: the pre-processing and dynamic scaling can provide effective customization of weights specific to particular inputs.

The technological improvement provided by these implementations may be measured by various performance metrics. For example, in some implementations, classification accuracy may improve by 5%, 10%, 15%, 20% or more compared to a neural network without dynamic pre-processing. In some implementations, training time may be reduced by 25%, 50%, 75% or more because a simpler neural network architecture can be used. In some implementations, inference time (the time to generate a classification for new input data) may be reduced by 10%, 20%, 30% or more because the neural network has fewer layers and connections. In some implementations, the amount of training data required may be reduced by 20%, 40%, 60% or more because the pre-processing handles much of the input-specific customization. These improvements may vary depending on the specific application domain, the complexity of the classification task, and the number of input parameters.

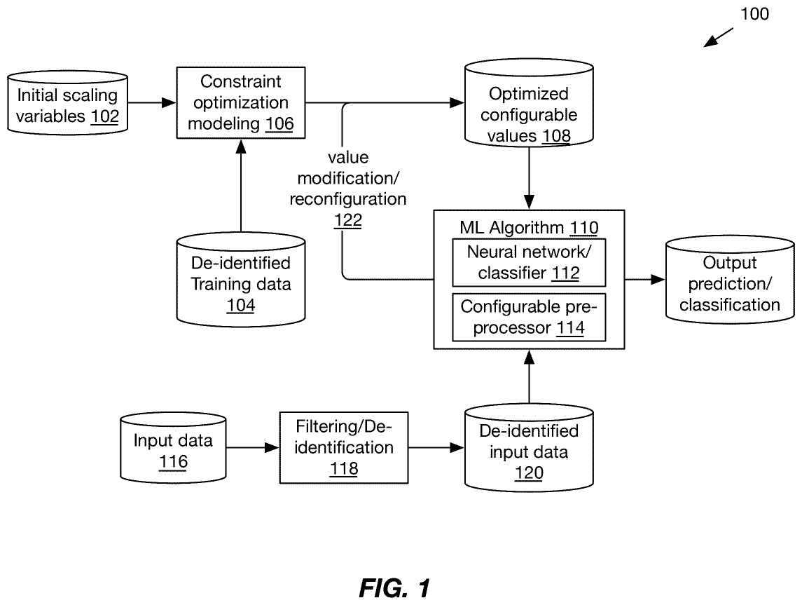

FIG. 1 is a block diagram of an implementation of a system for dynamic control of machine learning parameters. The system may include a machine learning algorithm configured to generate and output predictions or classifications from input data, using a model trained on training data. Input data, which may be of any type and form, may include patient diagnostic information, computing device or network performance measurements, environmental sensor data or measurements, or any other type and form of data for processing. In some implementations, input data may be filtered and/or de-identified, such as to generate anonymized training data, or to remove user or device specific identifiers prior to passing the data to the machine learning algorithm.

In some implementations, a machine learning algorithm, such as a deep neural network (DNN) or other classifier, may include a configurable pre-processor, referred to generally as a pre-processor, dynamic modifier, input agent, or by similar terms. The pre-processor may receive input data (which may be filtered or de-identified input data in implementations processing sensitive data) and may scale, normalize, or otherwise translate or modify the input data according to one or more configurable weights and thresholds. The weights and thresholds may be dynamically modified during pre-processing based on the input data and/or other scaling or normalization processes. This may be performed iteratively to generate a set of modified or intermediate data which may then be provided to a neural network or other classifier. In some implementations, initial configurable weights or threshold values may be determined through a constraint optimization modeling process based on training data, which may be de-identified, virtual or manufactured data, random data, or any other type and form of training data. Initial values for the weights and thresholds may be generated via a supervised learning system using initial scaling variables and optimization of training data, which may comprise de-identified actual data (e.g. measurements with client or device identifiers removed), manufactured or virtual data, or any other such data.

The constraint optimization modeling may utilize various optimization algorithms, such as gradient descent, simulated annealing, genetic algorithms, particle swarm optimization, or other suitable optimization techniques. In some implementations, the constraint optimization may define upper and lower bounds for configurable values (e.g., weights ranging from 0 to 10, multipliers ranging from 1 to 5) and may optimize these values to minimize error rates, maximize classification accuracy, or achieve other predetermined performance metrics on the training data. The optimization process may iteratively adjust configurable values and evaluate performance until convergence criteria are met, such as when improvements fall below a threshold or a maximum number of iterations is reached.

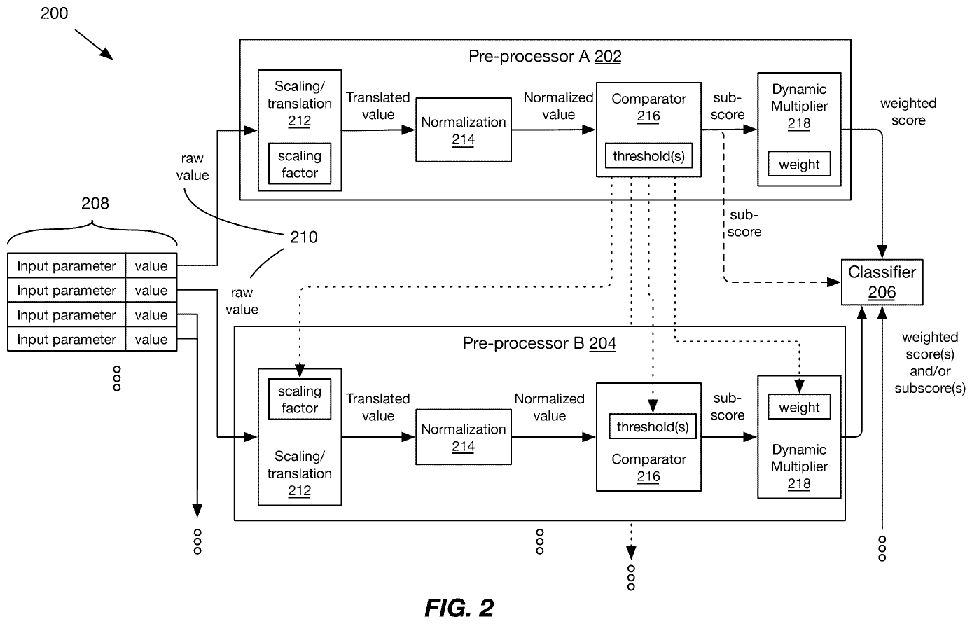

FIG. 2 is a block diagram of an implementation of dynamic control of machine learning parameters during processing. Input values may be associated with a parameter or type, which may vary based on the context and implementation. For example, an input parameter and value may be a distance or length and measurement such as might be used in a machine vision system; a pathology test and measurement such as might be used in a medical diagnostic system; a pixel and value such as might be used in an image recognition system, etc. Input values may not be explicitly identified with an associated parameter or type, but may be received as a concatenated string, array, table, or other such data format. In other implementations, input values may be explicitly identified, such as a user filling out a questionnaire with associated questions or measurement types and input values.

Input values, which may be referred to as raw values in some implementations, may be provided to one or more pre-processors. A pre-processor or pre-processors, which may execute in parallel or serial, may comprise an application, service, server, daemon, routine, or other executable logic for translating, scaling, normalizing, reweighting, or otherwise modifying raw values to generate one or more weighted scores or sub-scores to be provided as an input to a neural network or other classifier.

In some implementations, pre-processors may be implemented as hardware accelerators, such as field-programmable gate arrays (FPGAs), application-specific integrated circuits (ASICs), or specialized co-processors optimized for parallel computation of scaling, normalization, and comparison operations. Hardware implementation may provide significant speed advantages for real-time applications where latency is critical, such as autonomous vehicle control or high-frequency trading. In other implementations, pre-processors may be implemented as software modules, libraries, or microservices that execute on general-purpose processors, providing greater flexibility and ease of updating configurable values without hardware changes.

In some implementations, a pre-processor may include a scaling or translation engine to scale an input raw value by a scaling factor. In some implementations, the scaling factor may be predetermined or configured, such as via constraint optimization modeling on training data as discussed above. For example, in many implementations, raw values for input parameters may be of widely varying types, such as a processor utilization between 0-100%, a latency between 0-1000 ms, a memory utilization in megabytes or gigabytes, a blood pressure measurement with diastolic and systolic values, a creatine measurement in parts per million, a self-assessed depression score on a scale from 0-10, a height in centimeters, a number of hours slept on average per night, etc. Directly comparing these values may be near impossible due to the different scales. Accordingly, in some implementations, a scaling or translation engine may scale scores into predetermined ranges, with a parameter or type-specific scaling factor, to generate a translated or scaled value.

In some implementations, the translated or scaled value may be normalized. This may again use a parameter-specific normalization factor or formula which may take into account averages, distributions, standard deviations, etc. For example, some of the various example metrics discussed above may have very different distributions or require different normalization factors, such as a diastolic blood pressure measurement which is typically with a range of 60-80 mmHg and rarely higher or lower, or a depression score which may typically be a 0 or 1, but may be higher. Normalization functions may be continuous or discrete, linear or complex. A normalization engine of the pre-processor may apply the parameter-specific function to generate a normalized value. In some implementations, normalized values may be constrained to a predetermined range, e.g. 0-10, 0-100, or any other suitable range of values.

In some implementations, the normalized value (or translated value or raw value, in implementations in which a value is not normalized) may be compared to one or more thresholds (e.g. an upper threshold, lower threshold, and/or one or more intermediate thresholds). In some implementations, if the value exceeds a threshold (or does not meet a threshold, in various implementations), a dynamic multiplier may be applied to the value. For example, in one such implementation, if a normalized value meets or exceeds a threshold of 7 on a scale of 0-10, then a multiplier of 2 may be applied (e.g. scaling a 7 into a 14, 8 into a 16, 9 into an 18, and 10 into a 20, as well as any non-integer values in similar implementations). This may allow for weighting particular parameters more heavily than others. The value may be referred to variously as a sub-score, weighted score, weighted sub-score, or by similar terms. For example, in some implementations, the normalized value may be referred to as a sub-score and if a multiplier is applied, it may be referred to as a weighted sub-score. In other implementations, both values may be referred to in the same way, with a corresponding weight of either 1 or some other value. The sub-score may be provided to a classifier, such as a deep neural network (DNN) or other such machine learning system.

As shown, in many implementations, one or more factors for other values may be modified based on the result of a comparison of a value to one or more thresholds. For example, given a first value for a parameter A, based on whether or not it exceeds a threshold, a scaling factor, threshold, or multiplier weight for another parameter B may be dynamically modified. This may allow for an increased sensitivity on one parameter based on a value for another. For example, in one implementation, a network jitter value may have an associated high threshold and/or low weight as the value may be vulnerable to noise or external factors. However, responsive to a latency value exceeding a threshold, the jitter value may be decreased and/or weight increased to increase sensitivity of the classifier to jitter changes. In another example, a self-reported stress value may be weighted at a first value, but increased to a second value in response to a self-reported depression value, allowing the classifier to have higher sensitivity to stress-related correlations. These controls may be complex in many implementations, such as where a weight for a multiplier of a parameter may be increased responsive to multiple other parameters exceeding thresholds, or a first parameter exceeding a threshold but a second parameter not exceeding a threshold. Boolean logic may thus be applied to outputs of pre-processor comparators to control triggers for modifying factors, thresholds, and weights.

As shown, in some implementations, the system may include a pre-processor for each input parameter or type (with additional pre-processors indicated with ellipses). In other implementations, pre-processing may be performed iteratively for each parameter or type (e.g. generating a first sub-score for a first parameter, a second sub-score for a second parameter, etc.). In some implementations, pre-processing may be repeated several times, as threshold comparisons for later parameters may affect factors and weights for earlier parameters. In some such implementations, pre-processing may be repeated until sub-scores do not vary on successive iterations, or vary less than a predetermined amount: this may indicate that weight or factor adjustments are settled or complete for pre-processing.

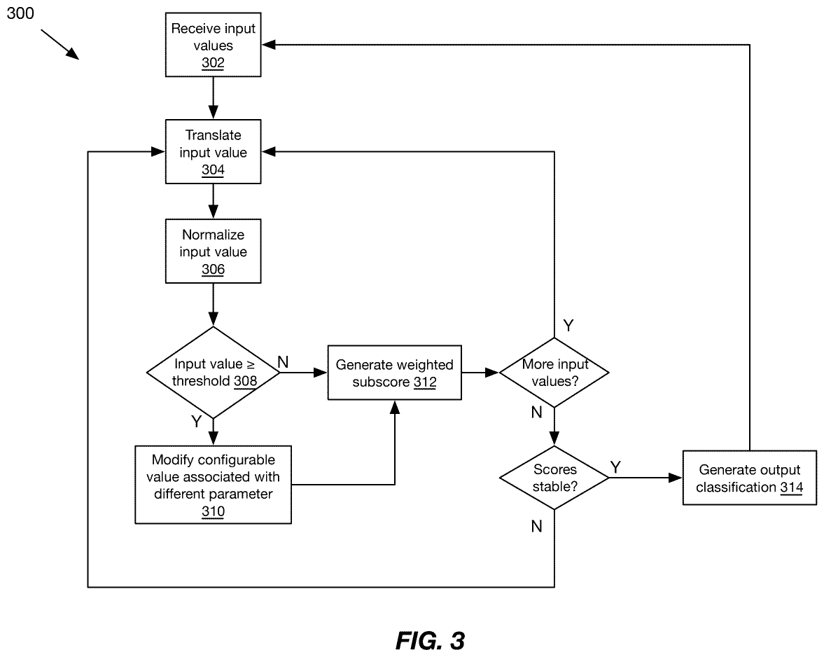

FIG. 3 is a flowchart illustrating an implementation of a method 300 for dynamic control of machine learning parameters during runtime. The method may be performed by a computing system comprising one or more processors executing one or more pre-processors and a trained machine learning classifier. The computing system may be on a single computing device, or may comprise a plurality of computing devices or architectures, including a compute cloud or cluster, a server farm, an appliance cluster, one or more virtual machines, etc. The flowchart illustrates the iterative nature of the pre-processing, including the dynamic modification of configurable values for parameters based on values of other parameters.

At step 302, in some implementations, a computing system may receive a plurality of input values. Each input value may be associated with a respective parameter of a plurality of parameters (e.g. as a parameter-value pair). In various implementations, the computing system may receive input values from a wide variety of sources, including user input devices such as keyboards, touchscreens, or voice recognition systems; sensors such as biometric sensors, environmental sensors, or network monitoring devices; databases or data stores containing historical or real-time measurements; application programming interfaces (APIs) providing data from external systems; or any other source of quantifiable data. For example, in a user questionnaire implementation, the computing system may receive input values comprising responses to questionnaire items. In a network monitoring implementation, the computing system may receive input values comprising latency measurements, packet loss rates, jitter values, bandwidth utilization percentages, or other network performance metrics. In a machine vision implementation, the computing system may receive input values comprising pixel intensities, edge detection scores, object recognition confidence values, or spatial relationship measurements. The plurality of parameters may number from two to hundreds or thousands, depending on the complexity of the classification task and the granularity of the input data. Input values may be received in any suitable format, such as a data array, database, flat file, delimeter separate values, concatenated string of values, etc.

At step 304, in some implementations, the computing system may translate each input value from a raw value to a translated value using a parameter-specific scaling factor. Translation may be necessary because raw input values for different parameters may have widely varying ranges, units, and interpretations. For example, one measurement may have a scale from 0-21, while another has a scale of 6-30. Direct comparison or aggregation of these disparate ranges would be meaningless without first translating them to comparable scales. The translation function may be linear, such as a simple scaling by a constant factor, or may be non-linear, such as a logarithmic, exponential, or piecewise function tailored to the distribution characteristics of the particular parameter. In some implementations, the pre-processor may translate non-numeric values to numeric equivalents, such as translating categorical responses (“never,” “sometimes,” “often,” “always”) to ordinal values (0, 1, 2, 3). The pre-processor may use a parameter-specific scaling factor that is predetermined based on the known range of the parameter, or dynamically determined based on observed minimum and maximum values in the input data or training data.

At step 306, in some implementations, the computing system may normalize each input value (or translated value) to generate a normalized value within a predetermined range. Normalization ensures that all parameters contribute proportionally to subsequent calculations regardless of their original scales. In many implementations, the predetermined range may be 0 to 10, 0 to 1, 0 to 100, or any other suitable range that facilitates consistent processing. The pre-processor may compute the normalized value by calculating a ratio of the difference between the translated value and a minimum translated value to the difference between a maximum translated value and the minimum translated value, and scaling the ratio to the predetermined range. In some implementations, the pre-processor may reverse an orientation of at least one input value such that normalized values for all parameters have a consistent directional meaning. For example, in some implementations, a first value may have a scale from 0-10 with 10 being an optimal or better reading and 0 being a non-optimal or worse reading; while a second value may have a reversed scale with 0 being better and 10 being worse. In such implementations, the computing system may reverse or remap values as needed so that all normalized values consistently represent the same directional meaning (e.g. with lower values indicating better higher scoring across all parameters). This orientation consistency may be important for subsequent aggregation and comparison of scores across different parameters.

At step 308, in some implementations, the computing system may compare a first normalized value for a first parameter to a first threshold value. The comparison may determine whether the normalized value meets or exceeds the threshold, which in turn controls whether the pre-processor will dynamically modify configurable values. The threshold value may be predetermined based on domain-specific knowledge, may be set by an administrator or developer, may be configured by a user, or may be determined through constraint-based optimization or machine learning training on historical data (e.g. gradient descent or another suitable algorithm). In some implementations, the system may compare the value to multiple thresholds, such as an upper threshold and a lower threshold defining a range, or a series of intermediate thresholds defining multiple severity levels. In some implementations, the system may also evaluate Boolean combinations of multiple conditions, such as determining that a first parameter exceeds its threshold and a second parameter does not exceed its threshold, or that any one of several parameters exceeds its respective threshold. Such Boolean logic allows the system to capture complex correlations and dependencies between parameters that would not be apparent from simple single-threshold comparisons. As discussed above, in many implementations, thresholds may be determined based on comparisons made by other pre-processors. For example, a first threshold may be set for a first input value for a first parameter based on a comparison of another parameter value to other thresholds.

At step 310, responsive to the first normalized value meeting or exceeding the first threshold value, the one or more pre-processors may dynamically modify one or more configurable values associated with a second parameter different from the first parameter. Unlike systems not implementing the methods discussed herein in which weights and hyperparameters are fixed after training, this inter-parameter dynamic modification allows for greater flexibility and sensitivity to highly nuanced correlations between parameters. In some implementations, the configurable values, sometimes referred to as pre-processing parameters, pre-processing hyperparameters, pre-processing weights, or by similar terms, may include a weight that determines how heavily the second parameter contributes to the final classification. In some implementations, the configurable values may include a multiplier that scales the second parameter's sub-score. In some implementations, the configurable values may include a scaling factor used during translation or normalization of the second parameter. In some implementations, the configurable values may include a threshold used in subsequent comparisons for the second parameter. Various implementations may include multiple configurable values of the same or different types, and modifications to configurable values for a first parameter may be different than modifications to configurable values for a second parameter. For example, in a mental wellness implementation, if a depression score (first parameter) exceeds a severity threshold, the pre-processor may increase the weight applied to a stress score (second parameter) to capture a clinically observed correlation between depression and stress sensitivity. In a network monitoring implementation, if a latency measurement (first parameter) exceeds a threshold indicating network congestion, the pre-processor may decrease the threshold for jitter (second parameter) to increase sensitivity to jitter-related issues that become more significant under congestion conditions. The pre-processor may also select between a triggered multiplier and a default multiplier based on whether the first normalized value meets or exceeds the first threshold value, allowing for non-linear amplification of scores that exceed clinically or operationally significant thresholds.

If the first normalized value does not meet or exceed the first threshold value, in some implementations, the system may proceed without modifying configurable values for other parameters, or may apply a default configurable value rather than a triggered configurable value. As discussed in more detail below, steps 304-310 may be repeated iteratively, and accordingly, in some implementations, a configurable value for a parameter may be modified during a first iteration and not modified during a second iteration. In some implementations, the pre-processor may still apply a default multiplier (as opposed to a triggered multiplier) to maintain consistent mathematical treatment of all parameters while still differentiating between threshold-exceeding and non-threshold-exceeding cases.

At step 312, in some implementations, the computing system may apply the dynamically modified configurable value to a second normalized value for the second parameter to generate a weighted sub-score for the second parameter. The computing system may calculate the weighted sub-score by multiplying the normalized value by a weight and by a dynamic multiplier. For example, if a normalized score is 7.5 (on a 0-10 scale), the parameter-specific weight is 8 (on a 1-10 scale), and the dynamic multiplier is 2 (because a threshold was exceeded, triggering an increased sensitivity), a pre-processor for the parameter may calculate a weighted sub-score as 7.5×8×2=120. In some implementations, the pre-processor may constrain the sub-scores to a maximum value to prevent any single parameter from disproportionately dominating the final classification. In other implementations, the pre-processor may allow the sub-scores to exceed typical ranges when thresholds are triggered, providing increased sensitivity to clinically or operationally significant conditions.

In some implementations, one or more of steps 304-312 may be repeated for each parameter, generating a plurality of weighted sub-scores that collectively represent the processed input data. This iterative processing continues until the computing system has processed all input values through the translation, normalization, and comparison steps. In implementations with parallel pre-processors, the computing system may process multiple parameters simultaneously, with inter-parameter modifications communicated between pre-processors via shared memory, message passing, or other inter-process communication mechanisms.

The order in which the computing system processes parameters may affect the final results in some implementations, as earlier threshold comparisons may modify configurable values used for later parameters. In some implementations, the computing system may predetermine the processing order based on parameter priority or clinical significance, or may randomize the order to reduce order-dependent biases. Furthermore, in some implementations, one or more of steps 304-312 may be iteratively repeated until the computing system determines that the weighted sub-scores have converged to stable values. Because threshold comparisons for some parameters may affect configurable values for other parameters, and those modified configurable values may in turn affect sub-scores that influence yet other threshold comparisons, the computing system may need to repeat the pre-processing iteratively until the sub-scores stabilize. In some implementations, the computing system may iteratively repeat the comparing, dynamically modifying, and applying steps until weighted sub-scores for the plurality of parameters vary by less than a predetermined amount on successive iterations. For example, if the sum of absolute differences between sub-scores on successive iterations falls below 0.01, or if no sub-score changes by more than 0.1%, the computing system may deem the scores stable. In some implementations, the computing system may impose a maximum number of iterations to prevent infinite loops in cases where scores oscillate without converging. Although shown returning to step 304, in some implementations, one or more of steps 304-306 may be skipped during subsequent iterations (e.g. if translation or normalization parameters are not modified, such that the previously generated normalized value may be used). In other implementations, such as where configurable values include scaling factors, steps 304 and 306 may be repeated during subsequent iterations. The application of these steps may be enabled or disabled based on changes to configurable values from a previous iteration. For example, if no configurable values have changed for a parameter during an iteration, in some implementations, iterative pre-processing of the corresponding input value may be skipped and the previously generated sub-score used during a subsequent iteration.

At step 314, in some implementations, the computing system may provide the weighted sub-score and one or more additional sub-scores for additional parameters to a trained machine learning classifier, and the trained machine learning classifier may generate an output classification or prediction based on the weighted sub-score and the one or more additional sub-scores. In some implementations, the computing system may provide the weighted sub-scores as an n-dimensional vector to a neural network, wherein n corresponds to a number of parameters in the plurality of parameters. For example, in a mental wellness implementation with 15 clinical scales, the 15 weighted sub-scores form a 15-dimensional input vector that the pre-processors provide to the trained classifier. The classifier may comprise a deep neural network (DNN), a convolutional neural network (CNN), a recurrent neural network (RNN), a support vector machine (SVM), a random forest, a gradient boosting machine, or any other type of trained machine learning model suitable for the classification or prediction task. The classifier may output a categorical label (e.g., “high risk,” “moderate risk,” “low risk”), a continuous score (e.g., a wellness score from 1 to 10), a probability distribution across multiple classes, or any other form of classification or prediction output.

In some implementations, the classifier may generate the output classification by determining a difference between a predetermined maximum value and a scaled ratio of a sum of all sub-scores to a sum of maximum possible weighted scores. For example, the classifier may calculate the final score by dividing the sum of all weighted sub-scores by the maximum possible sum (calculated as the sum of maximum normalized values multiplied by their respective weights, without triggered multipliers), scaling the ratio to a 0-10 range, and then inverting the result by subtracting from 10 so that a high score reflects a positive outcome rather than a negative outcome. The inversion step may be used to align the output with intuitive user expectations where higher scores are generally perceived as better. In some implementations, the classifier may also enforce a minimum output score, such as selecting the greater of a predetermined minimum value (e.g., 1) or the calculated score, to ensure that output scores remain within a defined range suitable for display and interpretation.

As a non-limiting example, an implementation of these systems and methods may be used in medical diagnostic systems. For example, relative to other forms of preventative risk assessment in health care, mental wellness risk has largely been ignored by consumers, employers, educators, providers and payers. Implementations of the systems and methods discussed herein can address this problem by providing a simple, affordable, comprehensive and clinically valid snapshot of mental wellness to adults over the age of 18 using an asynchronous online assessment incorporating dynamic weighting of parameters to a machine learning classifier to generate diagnostic reports. In some implementations, clinical decisions may be made based on the system outputs, including prescription and application of condition-specific pharmaceuticals or other medical interventions. The system may be provided as a web-based service or SaaS service, or may be executed on a client device locally in various implementations.

In some implementations, the system may monitor mental wellness without intervention from a clinician by quickly obtaining a snapshot of risk associated with mental wellness, e.g. via an online questionnaire. A number of clinically validated scales appropriate for online screening may be utilized in order to deliver a comprehensive view of mental wellness, such as the Brief Resilience Score (BRS); Epworth Sleepiness Scale; UCLA Loneliness scale; Bergens SMAS; ASRS-5; South Florida Brief Cognitive Screen; BEDS-7; GAD-7; PHQ-9; PTSD Stress Scale; ACES Adult 10 Item; World Health Organization Disability Assessment Schedule 2.0 (WHODAS 12); Fast Alcohol Screening Test; Drug Abuse Screening Test; Columbia-Suicide Risk Scale; or any other type and form of test or scale. The system may incorporate sub-scores from one or more of these scales to calculate a mental wellness score or classify the subject based on a proprietary risk formula. The score or classification may be provided in a Snapshot report delivered to a user, such as a patient or physician. The system may prompt the user to retest or retake questionnaires, and may record and track scores and/or classification changes over time.

Implementations of the system may analyze and surface reliable indicators of mental wellness based on a weighted blend of normalized scores from each of the validated scales included in the questionnaire(s). In some implementations, a high weighted score may be indicative of mental wellness, and a low weighted score may reflect challenges with mental wellness. The score from each questionnaire or session may be displayed in a report, such as via a visual indicator or scale ranging from Green (scores from 7 to 10), Yellow (scores from 5 to 6.9), or Red (scores from 1 to 4.9).

Accordingly, in this example implementation, the score or classification may be derived from raw scores for validated clinical scales, with the resulting normalized sub-scores for each scale being combined with configurable sub-score weights, triggers and multipliers. The machine learning system, such as a trained neural network, may calculate a mental wellness score or classification based on potential challenges and risks identified in the sub-scales, with dynamically adjusted weights during pre-processing. As discussed above, by utilizing pre-processing inter-parameter dynamic weighting, the neural network itself may be simpler and retraining requirements may be reduced.

In some implementations, the service may be provided to users via a web application technology stack including a NOSQL database or other such database, and an API infrastructure providing a Snapshot user interface and scoring algorithm. This technology stack may collect the results of each Snapshot submission, including the raw results derived from each scale, the calculated sub scores for each scale, and the determined Snapshot Score or other output score. Data from this system may be extracted, transformed, and loaded into a data visualization engine for analysis and operational reporting.

In some such implementations, a protected combination of validated, third party symptomatology and life experience scales that measure mental wellness may be utilized as user questionnaires or surveys, with raw scores from each scale converted to a normalized score (e.g. from 0 to 10) based on a scale or parameter-specific normalization formula. Each scale may be assigned a protected weight from 0 to 10 based on that scale's clinical value as a factor to determine mental wellness risk, and each scale may be assigned additional protected multipliers which may be triggered dynamically when the raw score for that scale reaches one or more discrete, protected thresholds. The multiplier(s) for each scale may determine a final sub score for that scale, which will then be included in the aggregate calculation of the Snapshot Score. In some implementations, after each sub score is calculated, it may be incorporated into the Snapshot Score in any suitable algorithm, such as via using a weighted ratio of the total of all sub scores to the maximum total sum of all normalized scores multiplied by their weights.

In some implementations, the system may generate and/or use simulated data for example raw result scenarios based on user personas and corresponding simulated survey results, allowing for training and optimization of weights. The system may measure the range of configurable values required to limit scores to the identified clinical target scenarios using a constraint based optimization formula. A machine learning workflow may be utilized to predict the most effective weights, triggers and multipliers for each scale, using the range of configurable values identified previously. The predictions may rely on neural network training using de-identified diagnosis data, simulated data, or other such training data sets, e.g., via a supervised learning process.

The supervised learning process for training the neural network classifier may utilize various training algorithms, such as backpropagation with stochastic gradient descent, Adam optimization, RMSprop, or other suitable training methods. The training data may be split into training, validation, and test sets in various ratios (e.g., 70/15/15, 80/10/10, or other suitable splits). The neural network architecture may comprise various configurations, such as: a feedforward network with one or more hidden layers containing 10 to 1000 neurons per layer; a recurrent network with long short-term memory (LSTM) or gated recurrent unit (GRU) cells; a convolutional network with one or more convolutional and pooling layers; or other suitable architectures. The output layer may use activation functions appropriate to the classification task, such as softmax for multi-class classification, sigmoid for binary classification, or linear activation for regression outputs.

In more detail for the above example implementation, each scale delivered through the questionnaire may be scored according to clinically validated scoring instructions associated with that scale, resulting in a Raw Score. This score may be retrieved or received in a raw or unprocessed format prior to translation and normalization. If a Raw Score is not a number, it may be translated into a numerical format for use with the algorithm (e.g. “unhappy”=−1, “content”=0, “happy”=1, etc.).

Raw Scores may be translated into a numerical Translated Score to match the ranges of scores specific to a scoring summary for that scale. For example, the Raw Score of the Brief Resilience Scale (BRS) can fall between 6 and 30, but the translated patient facing score is re-calculated to a range between 1 and 5. By using the Translated Score (and the range of those scores), normalization may allow realignment of the system to clinical intentions of the scale. Translation factors or functions for each Raw Score may be scale or parameter-specific.

The Translated Score may be converted or normalized to a Normalized Score (e.g., from 0 to 10). The Normalized Score is derived from the Translated Score using a formula specific to each scale or parameter that assures consistency of meaning between scales. For example, some scales have a “higher is better” orientation while others have a “lower is better” orientation. The former or latter may be reversed during normalization to match orientations of other scales.

In some implementations, a Normalized Score may be multiplied by a scale or parameter-specific Weight. After multiplying the Normalized Score by the Weight, the weighted score may be multiplied by a Dynamic Multiplier. This may be done under control of a comparator or responsive to a comparison to one or more threshold values. For example, if a score for a scale is equal to or above a predetermined threshold value, a first multiplier value may be used, while if the score is under the threshold value, a second multiplier value may be used. The threshold may be referred to in various implementations as a trigger, pathology trigger, multiplier trigger, or by similar terms. After the Dynamic Multiplier is determined, the previously derived product of the Normalized score multiplied by the Weight, is then multiplied again by the Dynamic Multiplier. The result is a sub-score for each scale.

One such implementation of this pre-processing may be as follows, with variables of:
Rᵢ: Raw score for scale i;
Tᵢ: Translated score for scale i;
Nᵢ: Normalized score for scale i (e.g., from 0 to 10);
Wᵢ: Weight for scale i (e.g., from 1 to 10);
TMᵢ: Triggered Multiplier for scale i (e.g., 1 to 5);
Dᵢ: Default Multiplier for scale i (e.g., 1 to 5);
DMᵢ: Dynamic Multiplier for scale i (Default or Triggered Multiplier);
PTᵢ: Pathology Trigger for scale i;
SSᵢ: Subscore for scale i; and
WS: Wellness Score or final classification score.
1. Convert the raw score to a Translated score:

$$T i = f ( R i )$$

2. Normalize the Translated score to a 0-10 scale:

$${N}_{i} = \frac{{T}_{i} - min ( {T}_{i} )}{max ( {T}_{i} ) - min ( {T}_{i} )} \times 10$$

3. Determine the Dynamic Multiplier:

$${DM}_{i} = \{ \begin{matrix}{TM}_{i} if {N}_{i} \geq {PT}_{i} \\ {D}_{i} otherwise\end{matrix}$$

4. Determine the subscore for each scale:

$$S {S}_{i} = {N}_{i} \times {W}_{i} \times D {M}_{i}$$

5. Calculate the final classification score:

$$W S = 10 - \frac{{\sum }_{i = 1}^{M} S {S}_{i}}{{\sum }_{i = 1}^{M} ( 10 \times {W}_{i} )} \times 10$$

6. Ensure a minimum score of 1:

$$max ( 1 , WS )$$

As shown above, in some implementations, a final score may be calculated by dividing the numerator of the sum of all Sub Scores, by the denominator of the maximum score possible for the sum of all normalized scores multiplied by their weights. Note that the numerator can exceed the denominator because the calculation for the Max Sub Score does not include the Triggered Multiplier. This may allow for scales that include multipliers to cause the WS to respond with appropriate sensitivity when the thresholds for those scales are triggered. After the ratio is determined between the numerator and denominator, it may be multiplied by 10 to show the score on a range from 0 to 10, and the result is then reversed by subtracting it from 10—so that a high score reflects mental wellness. If the resulting score is below one, the score may be rounded to one.

In a similar implementation, an intermediary score may be used with linear remapping within pre-specified scaled point quantiles. For example, in some implementations, after determining the subscore for each scale SSᵢ at step 4, an intermediate raw difficulty index or intermediate raw score may be generated as a sum of sub-scores divided by total possible sub-scores:

$${score}_{r a w} = \frac{{\sum }_{i = 1}^{M} {SS}_{i}}{{\sum }_{i = 1}^{M} ( 10 \times {W}_{i} )} .$$

The raw score may be mapped into a point quantiles based on weighted reference parameters ref_{low} and ref_{high}, which may comprise any appropriate values (e.g. 0.05, 0.10, 0.15, or any other such value for ref_{low}, and 0.85, 0.90, 0.95, or any other such value for ref_{high}) as:

$${score}_{m a p p e d} = \frac{( r e {f}_{h i g h} - {score}_{r a w} )}{( r e {f}_{h i g h} - r e {f}_{l o w} )} .$$

In some implementations, score_{mapped} may be inverted so that a higher score indicates a better classification or outcome. As discussed above, in some implementations, score_{mapped} may be clamped or forced to a predetermined range (e.g. score_{clamped}=min(max(score_{mapped},0),1)). The clamped score may be used as a final output score or, in some implementations, the clamped score may be scaled to a specified range:

$${score}_{f i n a l} = {display}_{min} + ( {display}_{max} - {display}_{min} ) * {score}_{m a p p e d} .$$

The final score may be rounded or truncated to one significant figure in some implementations to reduce complexity.

In some implementations, rather than aggregating the scores, each sub-score may be provided as a n-dimensional vector to a machine learning system or classifier, such as a neural network, with n corresponding to the number of scales or parameters.

The above example is intended to be non-limiting, and implementations of the systems and methods discussed herein may be used in many different industries and environments. The disclosed systems and methods provide a technological improvement to computing systems and machine learning technologies through the use of dynamically adjustable weights and multipliers in pre-processing, reducing complexity of subsequent classifiers or neural networks, and providing greater flexibility and accuracy without significant resource cost.

Additional non-limiting example applications may include: fraud detection systems where transaction parameters are dynamically weighted based on risk indicators from other parameters; predictive maintenance systems where sensor readings from machinery components have weights adjusted based on readings from related components; autonomous vehicle control systems where environmental sensor data is dynamically weighted based on driving conditions; cybersecurity systems where network traffic parameters are weighted based on threat indicators; and financial trading systems where market indicators are dynamically weighted based on correlations with other market conditions. In each such implementation, the inter-parameter dynamic weighting allows the system to capture complex, context-dependent correlations that would require significantly more complex neural network architectures if implemented through training alone.

In some aspects, the present disclosure is directed to a method for dynamic control of machine learning parameters during runtime. The method includes (a) receiving, by one or more pre-processors executed by a computing system, a plurality of input values, each input value associated with a respective parameter of a plurality of parameters. The method also includes (b) normalizing, by the one or more pre-processors, each input value to generate a normalized value within a predetermined range. The method also includes (c) comparing, by the one or more pre-processors, a first normalized value for a first parameter to a first threshold value. The method also includes (d) responsive to the first normalized value meeting or exceeding the first threshold value, dynamically modifying, by the one or more pre-processors, a configurable value associated with a second parameter different from the first parameter. The method also includes (e) applying, by the one or more pre-processors, the dynamically modified configurable parameter to a second normalized value for the second parameter to generate a weighted sub-score for the second parameter. The method also includes (f) providing the weighted sub-score and one or more additional sub-scores for additional parameters to a trained machine learning classifier of the computing system. The method also includes (g) generating, by the trained machine learning classifier, an output classification or prediction based on the weighted sub-score and the one or more additional sub-scores.

In a further implementation, the configurable value may comprise at least one of: a weight, a multiplier, a scaling factor, or a threshold. In a still further implementation, dynamically modifying the configurable value may comprise selecting between a triggered multiplier and a default multiplier based on whether the first normalized value meets or exceeds the first threshold value.

In another further implementation, dynamically modifying the configurable value associated with the second parameter different from the first parameter may be performed by a first pre-processor of the one or more pre-processors, and applying the dynamically modified configurable value to the second normalized value for the second parameter to generate the weighted sub-score for the second parameter may be performed by a second pre-processor of the one or more pre-processors.

In another further implementation, the method may further include, prior to step (b), translating each input value from a raw value to a translated value using a parameter-specific scaling factor. In another further implementation, normalizing may comprise reversing an orientation of at least one input value such that normalized values for all parameters have a consistent directional meaning.

In another further implementation, dynamically modifying the configurable value may be performed responsive to a Boolean combination of: (i) the first normalized value meeting or exceeding the first threshold value, and (ii) a third normalized value for a third parameter meeting or not meeting a second threshold value.

In another further implementation, the method may further include iteratively repeating the comparing, dynamically modifying, and applying steps until weighted sub-scores for the plurality of parameters vary by less than a predetermined amount on successive iterations. This convergence check ensures that all inter-parameter dependencies are fully resolved before the final classification is generated.

In another further implementation, providing the weighted sub-score and the one or more additional sub-scores may comprise providing an n-dimensional vector to a neural network, wherein n corresponds to a number of parameters in the plurality of parameters.

In another further implementation, generating the output classification may further comprise determining a value proportional to a ratio of a sum of all sub-scores to a sum of maximum possible weighted scores. The classifier may calculate this ratio, scale it to a predetermined range, and optionally invert the result so that higher output values indicate more favorable outcomes.

In another aspect, the present disclosure is directed to a computing system for dynamic control of machine learning parameters during runtime. The system may include one or more processors executing one or more pre-processors and a trained machine learning classifier. The one or more pre-processors may be configured to: receive a plurality of input values, each input value associated with a respective parameter of a plurality of parameters; normalize each input value to generate a normalized value within a predetermined range; compare a first normalized value for a first parameter to a first threshold value; responsive to the first normalized value meeting or exceeding the first threshold value, dynamically modify a configurable value associated with a second parameter different from the first parameter; apply the dynamically modified configurable value to a second normalized value for the second parameter to generate a weighted sub-score for the second parameter; and provide the weighted sub-score and one or more additional sub-scores for additional parameters to the trained machine learning classifier. The trained machine learning classifier may be configured to generate an output classification or prediction based on the weighted sub-score and the one or more additional sub-scores.

In a further implementation, the configurable value comprises at least one of: a weight, a multiplier, a scaling factor, or a threshold. In a still further implementation, the one or more pre-processors of the computing system may be further configured to select between a triggered multiplier and a default multiplier based on whether the first normalized value meets or exceeds the first threshold value.

In another further implementation, a first pre-processor of the one or more pre-processors of the computing system may be configured to dynamically modify the configurable value associated with the second parameter different from the first parameter, and a second pre-processor of the one or more pre-processors may be configured to apply the dynamically modified configurable value to the second normalized value for the second parameter to generate the weighted sub-score for the second parameter.

In another further implementation, the one or more pre-processors of the computing system may be further configured to, prior to normalizing, translate each input value from a raw value to a translated value using a parameter-specific scaling factor.

In another further implementation, the one or more pre-processors of the computing system may be further configured to reverse an orientation of at least one input value such that normalized values for all parameters have a consistent directional meaning.

In another further implementation, the one or more pre-processors of the computing system may be further configured to dynamically modify the configurable value responsive to a Boolean combination of: (i) the first normalized value meeting or exceeding the first threshold value, and (ii) a third normalized value for a third parameter meeting or not meeting a second threshold value.

In another further implementation, the one or more pre-processors of the computing system may be further configured to iteratively repeat the comparing, dynamically modifying, and applying steps until weighted sub-scores for the plurality of parameters vary by less than a predetermined amount on successive iterations.

In another further implementation, the one or more pre-processors of the computing system may be further configured to provide an n-dimensional vector to a neural network, wherein n corresponds to a number of parameters in the plurality of parameters.

In another further implementation, the trained machine learning classifier of the computing system may be further configured to generate the output classification based on a value proportional to a ratio of a sum of all sub-scores to a sum of maximum possible weighted scores.

### B. Computing Environment

Having discussed specific embodiments of the present solution, it may be helpful to describe aspects of the operating environment as well as associated system components (e.g., hardware elements) in connection with the methods and systems described herein. The systems discussed herein may be deployed as and/or executed on any type and form of computing device, such as a computer, network device, appliance, including virtual computing devices or a virtualized environment (e.g. one or more virtual machines executed by one or more physical computing devices) capable of communicating on any type and form of network and performing the operations described herein. Unless indicated otherwise, or technically precluded, the aspects described in this application can be used individually or in combination. Various numeric values are used in the present application, for example. The specific values are for example purposes and the aspects described are not limited to these specific values.

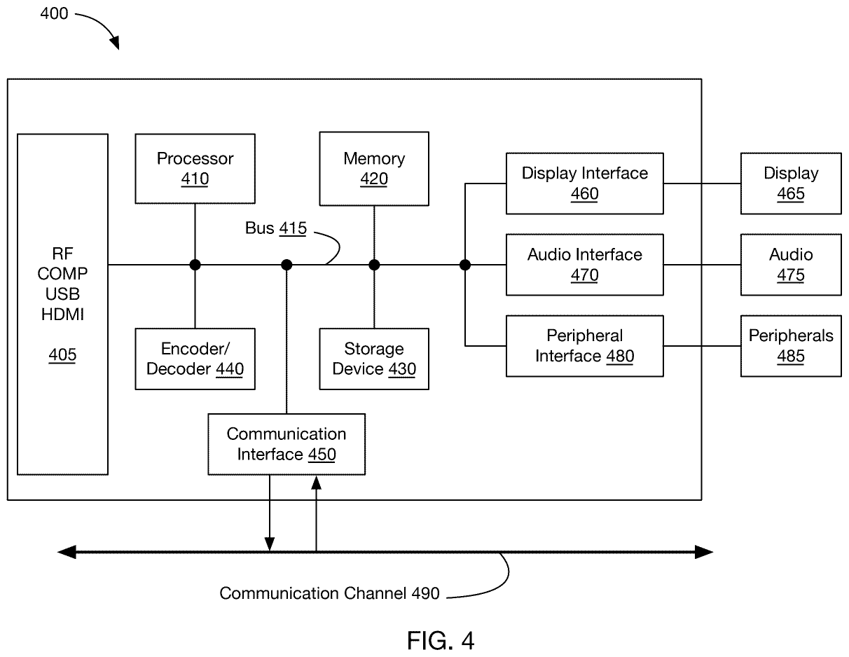

FIG. 4 illustrates a block diagram of an example of a system in which various aspects and embodiments can be implemented. System 400, which may be variously referred to as a computing system, computing device, computing architecture, client device, host device, server, appliance, or by other such terms, may be embodied as one or more devices including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. In some implementations, system 400 may comprise a plurality of computing devices, including an appliance cluster, a server farm, or other such architectures. In some implementations, system 400 may comprise one or more virtual computing devices executed by one or more physical computing devices, such as a server cloud, compute cloud, storage cloud, processing cloud, or similar architectures for scalable and/or distributed computing.

Elements of system 400, singly or in combination, may be embodied in a single integrated circuit, multiple ICs, and/or discrete components. For example, in at least one embodiment, the processing and encoder/decoder elements of system 400 are distributed across multiple ICs and/or discrete components. In various embodiments, the system 400 is communicatively coupled to other systems, or to other electronic devices, via, for example, a communications bus or through dedicated input and/or output ports. In various embodiments, the system 400 is configured to implement one or more of the aspects described in this application.

The system 400 may include at least one processor 410 configured to execute instructions loaded therein for implementing, for example, the various aspects described in this application. Processor 410 may include embedded memory, input output interface, and various other circuitries. In many embodiments, the central processing unit 410 is provided by a microprocessor unit, such as: those manufactured by Intel Corporation of Mountain View, California; those manufactured by International Business Machines of White Plains, New York; or those manufactured by Advanced Micro Devices of Sunnyvale, California. In virtualized or cloud environments, processors may also include virtualization extensions (e.g., Intel VT-x, AMD-V) to support hypervisors and virtual machines. The system 400 may be based on any of these processors, or any other processor capable of operating as described herein. As discussed above, in some implementations, processor 410 may be a virtual processor executed by a physical processor. In some implementations, processor 410 may be a tensor processing unit (TPU), a cryptographic processor or cryptoprocessor, or other such processors or co-processors.

The system 400 may include at least one memory 420 (e.g., a volatile memory device, and/or a non-volatile memory device), referred to variously as a memory device, main memory, cache memory, or by similar terms. Memory 420 may include non-volatile memory and/or volatile memory, including, but not limited to, static random access memory (SRAM), dynamic random access memory (DRAM), ferroelectric RAM (FRAM), NAND Flash, NOR Flash or Solid State Drive (SSD), programmable read only memory (PROM) or electrically erasable programable read only memory (EEPROM), magnetic disk drives, and/or optical disk drives. Memory 420 may be based on any of the above described memory chips, or any other available memory chips capable of operating as described herein. In addition, memory may include volatile and non-volatile components managed by modern memory hierarchies optimized for cloud workloads. Memory 420 may be external to processor 410 and/or internal to processor 410 (e.g. onboard cache memory, L2 memory, etc.)

System 400 may also include a storage device 430, which may include non-volatile memory and/or volatile memory, including, but not limited to, SRAM, DRAM, FRAM, NAND Flash, NOR Flash, SSD, PROM, EEPROM, magnetic disk drives, and/or optical disk drives. The storage device 430 may include an internal storage device, an attached storage device, and/or a network accessible storage device, as non-limiting examples. In some implementations, storage device 430 may be provided by another computing device and/or virtual computing device, such as a storage cloud.

In some implementations, system 400 may comprise a graphics processor 440, variously referred to as a graphics processing unit (GPU), encoder/decoder module, or by similar terms and configured, for example, to process data to provide images, video, 3D objects or environments, or other such data. Graphics processor 440 may include its own processor and memory. The graphics processor 440 represents module(s) that may be included in a device to perform various media encoding and/or decoding functions. In some implementations, a device may include a dedicated graphics processor for encoding and another graphics processor for decoding media or data. Graphics processor 440 may be implemented as a separate element of system 400 or may be incorporated within processor 410 as a combination of hardware and software.

Program code to be loaded onto processor 410 or graphics processor 440 to perform the various aspects described in this application may be stored in storage device 430 and subsequently loaded onto memory 420 for execution by processor 410 or graphics processor 440. In accordance with various embodiments, one or more of processor 410, memory 420, storage device 430, and graphics processor 440 may store one or more of various items during the performance of the processes described in this application. Such stored items may include operational logic, data for processor and/or processed data, encrypted data, compressed data, binary data, arrays, vectors, strings, textual data, image data, video data, audio data, 3D object data or environmental data, matrices, variables, and intermediate or final results from the processing of equations, formulas, operations, and operational logic, or any other type and form of data.

In several embodiments, memory inside of the processor 410 and/or the graphics processor 440 is used to store instructions and to provide working memory for processing functions. In other embodiments, a memory external to the processing device (e.g., processor 410 or the graphics processor 440) is used for one or more of these functions. The external memory may be the memory 420 and/or the storage device 430, for example, a dynamic volatile memory and/or a non-volatile flash memory.

Inputs to the elements of system 400 may be provided through various input devices as indicated in block 405. Such input devices include, but are not limited to, (i) an RF portion that receives an RF signal transmitted, for example, over the air by a broadcaster, (ii) a composite input terminal, (iii) a USB input terminal, and/or (iv) an HDMI input terminal.

In various embodiments, the input devices of block 405 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410 and/or graphics processor 440 operating in combination with the memory and storage elements to process the data stream as necessary for presentation on an output device.

Various elements of system 400 may be provided within an integrated housing, Within the integrated housing, the various elements may be interconnected and transmit data therebetween using suitable connection arrangement 415, for example, an internal bus. Various buses 415 may be used to connect between components of system 400 including, for example, a VESA VL bus, an ISA bus, an EISA bus, a MicroChannel Architecture (MCA) bus, a PCI bus, a PCI-X bus, a PCI-Express bus, an I2C bus, a controller area network (CAN) bus, or any other such interconnection system. Some embodiments may utilize PCIe Gen4 or Gen5 buses for higher bandwidth connections and GPU support for artificial intelligence workloads.

The system 400 may include one or more communication interface(s) 450 that enable communication with other devices via one or more communication channel(s) 490. Communication interface(s) 450 may include, without limitation, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax, and direct asynchronous connections). In some implementations, connections may use a gateway or tunneling protocol such as Secure Socket Layer (SSL) or Transport Layer Security (TLS). In some implementations, connections may include support for 5G, LTE, and/or high-speed fiber-optic networks, and/or advanced security protocols such as IPsec or TLS 1.3. Communication interface(s) 450 may include a transceiver configured to transmit and to receive data over a communication channel 490. The communication interface 450 may include, but is not limited to, a modem or network card and the communication channel 490 may be implemented, for example, within a wired and/or a wireless medium. For example, communication interface 450 may be a network interface card (NIC) or network adapter, PCMCIA network card, card bus network adapter, wireless network adapter, USB network adapter, modem, or any other device suitable for interfacing the computing device 400 to any type of network capable of communication and performing the operations described herein. In some implementations, systems may also include support for virtual private networks (VPNs), cloud-based software-defined networking (SDN), and edge computing frameworks to facilitate secure, scalable communication.

The system 400 may provide an output signal to various output devices, including a display 465, speakers 475, and other peripheral devices 485. The other peripheral devices 485 include, in various examples of embodiments, one or more of a stand-alone DVR, a disk player, a stereo system, a lighting system, and other devices that provide a function based on the output of the system 400. In various embodiments, control signals are communicated between the system 400 and the display 465, speakers 475, or other peripheral devices 485 using signaling such as AV.Link, CEC, or other communications protocols that enable device-to-device control with or without user intervention. The output devices may be communicatively coupled to system 400 via dedicated connections through respective interfaces 460, 470, and 480. Alternatively, the output devices may be connected to system 400 using the communications channel 490 via the communications interface 450. The display 465 and speakers 475 may be integrated in a single unit with the other components of system 400 in an electronic device, for example, a television. In various embodiments, the display interface 460 includes a display driver, for example, a timing controller (T Con) chip. Some implementations may also support high-resolution displays, including 4K or 8K monitors, and/or virtual reality (VR) or augmented reality (AR) headsets for immersive experiences. Furthermore, advanced GPUs, such as those provided by NVIDIA or AMD, may support AI-enhanced rendering and real-time ray tracing.

The display 465 and speaker 475 may be separate from one or more of the other components, for example, if an RF portion of input 405 is part of a separate set-top box. In various embodiments in which the display 465 and speakers 475 are external components, the output signal may be provided via dedicated output connections, including, for example, HDMI ports, USB ports, or COMP outputs.

System 400 may operate under the control of an operating system, which controls scheduling of tasks and access to system resources. The system 400 can be running any operating system such as any of the versions of the MICROSOFT WINDOWS operating systems, the different releases of the Unix and Linux operating systems, any version of the MAC OS for Macintosh computers, any embedded operating system, any real-time operating system, any open-source operating system, any proprietary operating system, any operating systems for mobile computing devices, or any other operating system capable of running on the computing device and performing the operations described herein. Operating systems include, but are not limited to: Android, produced by Google Inc.; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others. In cloud computing environments, operating systems may also include containerized operating environments, such as Kubernetes or Docker, enabling distributed, scalable deployments of microservices.

The system 400 can be any workstation, telephone, desktop computer, laptop or notebook computer, server, handheld computer, mobile telephone or other portable telecommunications device, media playing device, a gaming system, mobile computing device, or any other type and/or form of computing, telecommunications, or media device that is capable of communication. Some computing systems include cloud-based virtual machines, serverless architectures, and/or edge devices designed for IoT applications. The system 400 has sufficient processor power and memory capacity to perform the operations described herein.

In some embodiments, the system 400 may have different processors, operating systems, and input devices consistent with the device. For example, in one embodiment, the system 400 is a smartphone, mobile device, tablet, or personal digital assistant. In still other embodiments, the system 400 is an Android-based mobile device, an iPhone smartphone manufactured by Apple Computer of Cupertino, California, or a Blackberry or WebOS-based handheld device or smartphone, such as the devices manufactured by Research In Motion Limited. In some embodiments, the computing device may be a tablet computing device such as the Apple iPad, Surface devices by Microsoft, or advanced wearable devices such as smartwatches and AR glasses, which operate in conjunction with cloud-based services. Moreover, the system 400 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users,” such “users” may refer to user-associated devices or stations (STAs), for example, consistent with the terms “user” and “multi-user” typically used in the context of a multi-user multiple-input and multiple-output (MU-MIMO) environment. In some embodiments, “users” may also include virtualized clients, software agents, or autonomous systems interfacing through cloud-hosted platforms or distributed networks.

It should be noted that certain passages of this disclosure may reference terms such as “first” and “second” in connection with devices, modes of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components, and these components may be provided on either a standalone machine or, in some embodiments, on multiple machines in a distributed system. In cloud architectures, these components may be distributed across virtual machines, containers, or serverless functions within one or more data centers, with orchestration handled by platforms such as Kubernetes, OpenShift, or AWS Lambda. In addition, the systems and methods described above may be provided as one or more computer-readable programs or executable instructions embodied on or in one or more articles of manufacture.

The article of manufacture may be a floppy disk, a hard disk, a CD-ROM, a flash memory card, a PROM, a RAM, a ROM, or a magnetic tape. In general, the computer-readable programs may be implemented in any programming language or framework, including LISP, PERL, C, C++, C#, PROLOG, Python, Go, Rust, JavaScript (e.g., Node.js), or Java. Additionally, software may be developed using frameworks such as TensorFlow or PyTorch for AI workloads, or React and Angular for front-end applications. The software programs or executable instructions may be stored on or in one or more articles of manufacture as object code. Cloud-native applications may also utilize containerized environments, distributed ledgers, or serverless architectures, allowing code to execute dynamically based on predefined triggers and scaling conditions.

In embodiments leveraging software as a service (SaaS), the systems may operate entirely in cloud-hosted environments, enabling users to interact through browser-based interfaces or lightweight client applications, and functionality may be delivered over a network such as the Internet without requiring installation on local devices.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment. Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

What is claimed is:

1. A method for dynamic control of machine learning parameters during runtime, the method comprising:
(a) receiving, by one or more pre-processors executed by a computing system, a plurality of input values, each input value associated with a respective parameter of a plurality of parameters;
(b) normalizing, by the one or more pre-processors, each input value to generate a normalized value within a predetermined range;
(c) comparing, by the one or more pre-processors, a first normalized value for a first parameter to a first threshold value;
(d) responsive to the first normalized value meeting or exceeding the first threshold value, dynamically modifying, by the one or more pre-processors, a configurable value associated with a second parameter different from the first parameter;
(e) applying, by the one or more pre-processors, the dynamically modified configurable parameter to a second normalized value for the second parameter to generate a weighted sub-score for the second parameter;
(f) providing the weighted sub-score and one or more additional sub-scores for additional parameters to a trained machine learning classifier of the computing system; and
(g) generating, by the trained machine learning classifier, an output classification or prediction based on the weighted sub-score and the one or more additional sub-scores.

2. The method of claim 1, wherein the configurable value comprises at least one of: a weight, a multiplier, a scaling factor, or a threshold.

3. The method of claim 2, wherein dynamically modifying the configurable value comprises selecting between a triggered multiplier and a default multiplier based on whether the first normalized value meets or exceeds the first threshold value.

4. The method of claim 1, wherein dynamically modifying the configurable value associated with the second parameter different from the first parameter is performed by a first pre-processor of the one or more pre-processors; and wherein applying the dynamically modified configurable parameter to the second normalized value for the second parameter to generate the weighted sub-score for the second parameter is performed by a second pre-processor of the one or more pre-processors.

5. The method of claim 1, further comprising, prior to (b), translating each input value from a raw value to a translated value using a parameter-specific scaling factor.

6. The method of claim 1, wherein normalizing comprises reversing an orientation of at least one input value such that normalized values for all parameters have a consistent directional meaning.

7. The method of claim 1, wherein dynamically modifying the configurable value is performed responsive to a Boolean combination of: (i) the first normalized value meeting or exceeding the first threshold value, and (ii) a third normalized value for a third parameter meeting or not meeting a second threshold value.

8. The method of claim 1, further comprising iteratively repeating (c) through (e) until weighted sub-scores for the plurality of parameters vary by less than a predetermined amount on successive iterations.

9. The method of claim 1, wherein providing the weighted sub-score and the one or more additional sub-scores comprises providing an n-dimensional vector to a neural network, wherein n corresponds to a number of parameters in the plurality of parameters.

10. The method of claim 1, wherein generating the output classification further comprises determining a value proportional to a ratio of a sum of all sub-scores to a sum of maximum possible weighted scores.

11. A system for dynamic control of machine learning parameters during runtime, the system comprising:
one or more processors executing one or more pre-processors and a trained machine learning classifier;
wherein the one or more pre-processors are configured to:
(a) receive a plurality of input values, each input value associated with a respective parameter of a plurality of parameters,
(b) normalize each input value to generate a normalized value within a predetermined range,
(c) compare a first normalized value for a first parameter to a first threshold value,
(d) responsive to the first normalized value meeting or exceeding the first threshold value, dynamically modify a configurable value associated with a second parameter different from the first parameter,
(e) apply the dynamically modified configurable value to a second normalized value for the second parameter to generate a weighted sub-score for the second parameter, and
(f) provide the weighted sub-score and one or more additional sub-scores for additional parameters to a trained machine learning classifier; and
wherein the trained machine learning classifier is configured to generate an output classification or prediction based on the weighted sub-score and the one or more additional sub-scores.

12. The system of claim 11, wherein the configurable value comprises at least one of: a weight, a multiplier, a scaling factor, or a threshold.

13. The system of claim 12, wherein the one or more pre-processors are further configured to select between a triggered multiplier and a default multiplier based on whether the first normalized value meets or exceeds the first threshold value.

14. The system of claim 11, wherein a first pre-processor of the one or more pre-processors is configured to dynamically modify the configurable value associated with the second parameter different from the first parameter; and wherein a second pre-processor of the one or more pre-processors is configured to apply the dynamically modified configurable value to the second normalized value for the second parameter to generate the weighted sub-score for the second parameter.

15. The system of claim 11, wherein the one or more pre-processors are further configured to, prior to (b), translate each input value from a raw value to a translated value using a parameter-specific scaling factor.

16. The system of claim 11, wherein the one or more pre-processors are further configured to reverse an orientation of at least one input value such that normalized values for all parameters have a consistent directional meaning.

17. The system of claim 11, wherein the one or more pre-processors are further configured to dynamically modify the configurable value responsive to a Boolean combination of: (i) the first normalized value meeting or exceeding the first threshold value, and (ii) a third normalized value for a third parameter meeting or not meeting a second threshold value.

18. The system of claim 11, wherein the one or more pre-processors are further configured to iteratively repeat (c) through (e) until weighted sub-scores for the plurality of parameters vary by less than a predetermined amount on successive iterations.

19. The system of claim 11, wherein the one or more pre-processors are further configured to provide an n-dimensional vector to a neural network, wherein n corresponds to a number of parameters in the plurality of parameters.

20. The system of claim 11, wherein the trained machine learning classifier is further configured to generate the output classification based on a value proportional to a ratio of a sum of all sub-scores to a sum of maximum possible weighted scores.
